(19) United States
(12) Patent Application Publication
(10) Pub. No.: US 2010/0155179 A1
(43) Pub. Date: Jun. 24, 2010

(54) Lubricant filling assembly for transmission

(75) Inventors: Chien-Cheng Lin, Taichung City (TW); Po-Chin Su, Taichung City (TW)

Correspondence Address: CHARLES E. BAXLEY, ESQUIRE, 90 JOHN STREET, SUITE 309, NEW YORK, NY, 10038, US

(73) Assignee: Hiwin Mikrosystem Corp.

(21) Appl. No.: 12/317,199

(22) Filed: Dec. 19, 2008

(51) Int. Cl. F16N 1/00; F16N 7/30

(52) U.S. Cl. 184/100

(57) ABSTRACT

A lubricant filling assembly adaptive to various transmissions used in manufacturing processes for such as semiconductor equipments, LCD equipments and other automatic equipments. In practical use, the lubricant filling assembly is attached to surface of a transmission for providing a lubricant so as to enhance working efficiency of the transmission by reducing component friction and operational noise.

### BACKGROUND OF THE INVENTION

1. Technical Field

The present invention relates to lubricant filling assemblies for transmissions, and more particularly, to a lubricant filling assembly adaptive to various transmissions used in manufacturing processes for, not limited to, semiconductor equipments, LCD equipments and other automatic equipments. In practical use, the lubricant filling assembly may be attached to surface of a transmission for providing a lubricant.

2. Description of Related Art

As well know in the art, a transmission for precise processing tends to give high heat and operational noise. On the other hand, resistance out of friction among mechanical components can not only consume energy but also burden the motor. Consequently, after a certain period of use, the transmission is adversely affected.

To remedy the problems related to over heat, operational noise and friction, currently available transmissions for precise processing are, in the main, set with relatively low running power, ranging from about 10% to about 25%, only. Though this conventional approach helps to prevent the worries, the efficiency of transmissions is yet sacrificed for not giving the optimum interest thereof.

In view of this, a lubricant filling assembly hidden in a transmission has been developed. Referring to FIG. 5, the device comprises an inlet 112 mounted on a nut 111 of the transmission for allowing lubricant to be filled through the inlet 112. The introduced lubricant can then be led to surface of a screw in the transmission so as to provide lubricative and cooling effects. While being beneficial for industrial application in some measure, such device is nevertheless inconvenient in use. As can be understood form FIG. 5, the inlet 112 is accessible unless a top cover 30 of the transmission is removed. However, in LCD equipments or other automatic equipments, such a transmission may be arranged deeply inside the equipment and it becomes even more difficult for an operator to reach the inlet of the lubricant filling assembly. Considerable time and human energy may be consumed in disassembling, filling lubricant and then reassembling the equipment. Hence, a need exits for a lubricant filling assembly allowing lubricant filling operation that is more efficient, more economic and less complex.

### SUMMARY OF THE INVENTION

One objective of the present invention is to provide a lubricant filling assembly that serves to deliver a lubricant to a screw of a transmission so as to enhance working efficiency of the transmission by reducing component friction and operational noise.

Another objective of the present invention is to provide a lubricant filling assembly that appears at a surface of a transmission having it so that a lubricant can be fed thereinto without removing a top cover of the transmission.

To achieve these and other objectives of the present invention, the disclosed transmission primarily comprises:
a housing, receiving therein at least one screw;
at least one nut mounted around the screw and moving along the screw;
a slider mounted on and driven by the nut, the slider having at least one exposed portion at each of two sides thereof; and
at least one top cover placed on the housing in the manner that the top cover and the housing are partially spaced at two sides thereof; and
at least one said lubricant filling assembly, each is settled at one said exposed portion of the slider, the lubricant filling assembly comprising at least one connecting piece which has one end attached to an end of the exposed portion of the slider and includes at least one lubricant inlet and at least one air pressure connector.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a perspective view of a transmission assembled with a lubricant filling assembly of the present invention;

FIG. 2 is a partially enlarged drawing of the assembly of FIG. 1;

FIG. 3 illustrates how the lubricant filling assembly of the present invention is assembled to a slider of the transmission;

FIG. 4 is an applied view of the lubricant filling assembly of the present invention;

FIG. 5 shows a conventional transmission; and

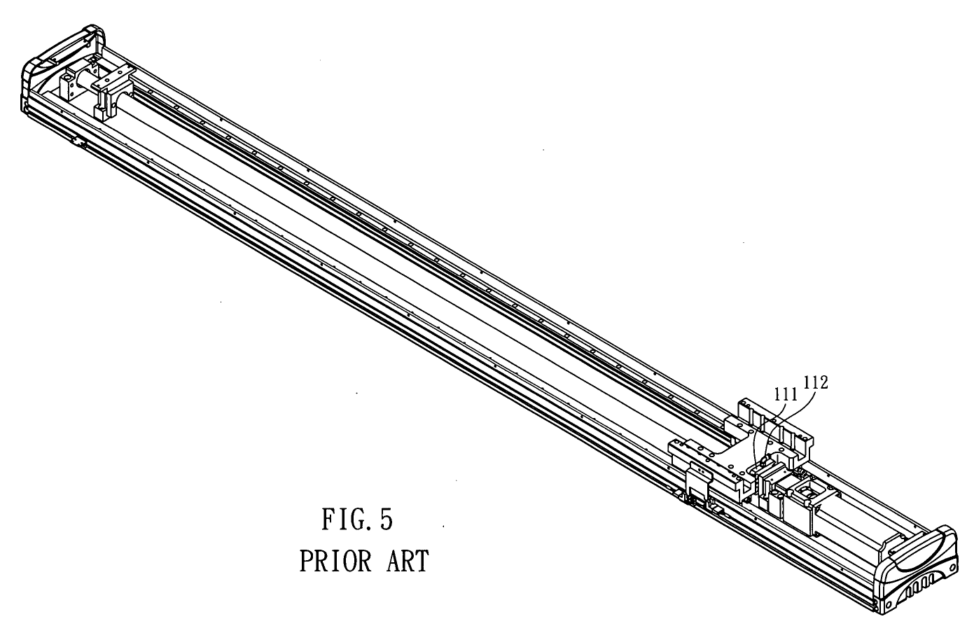

FIG. 6 shows a conventional transmission in another aspect.

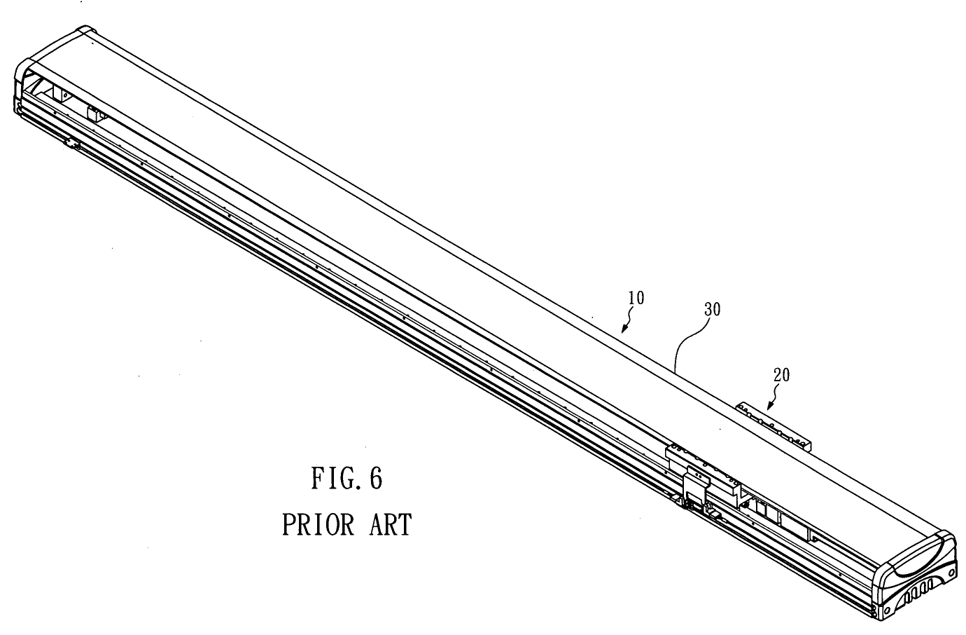

### DETAILED DESCRIPTION OF THE PREFERRED EMBODIMENTS

While a preferred embodiment is provided herein for illustrating the concept of the present invention as described above, it is to be understood that the components in these drawings are made for better explanation and need not to be made in scale. Moreover, in the following description, resemble components are indicated by the same numerals.

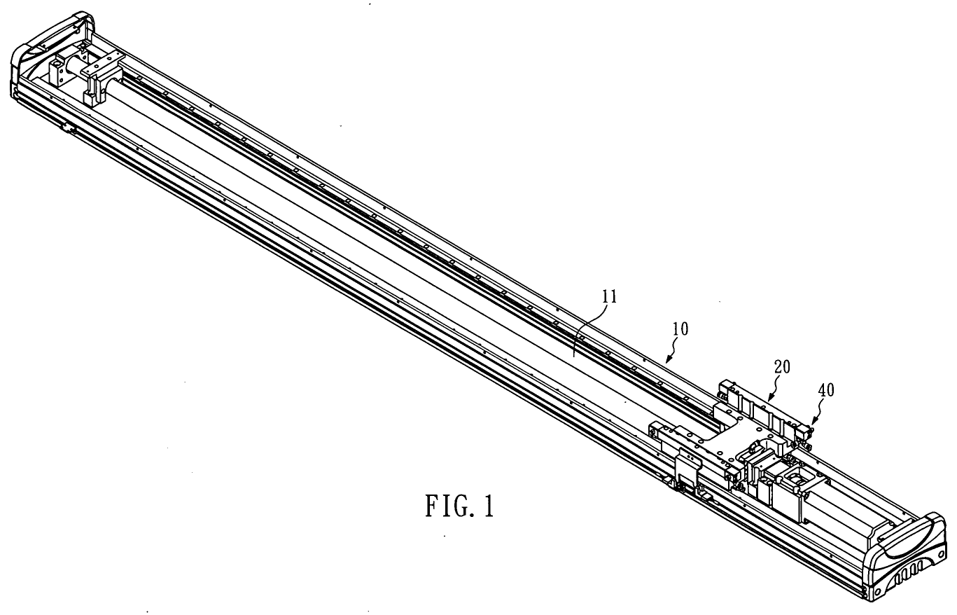

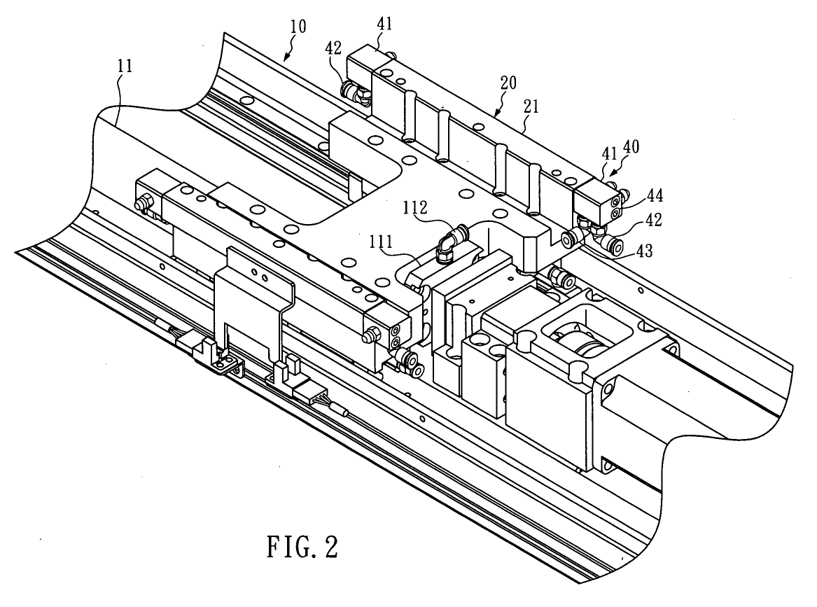

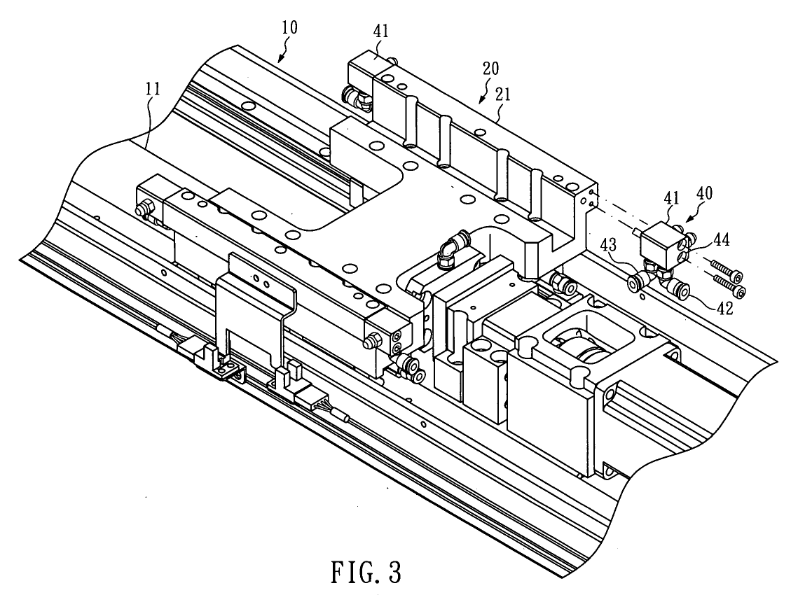

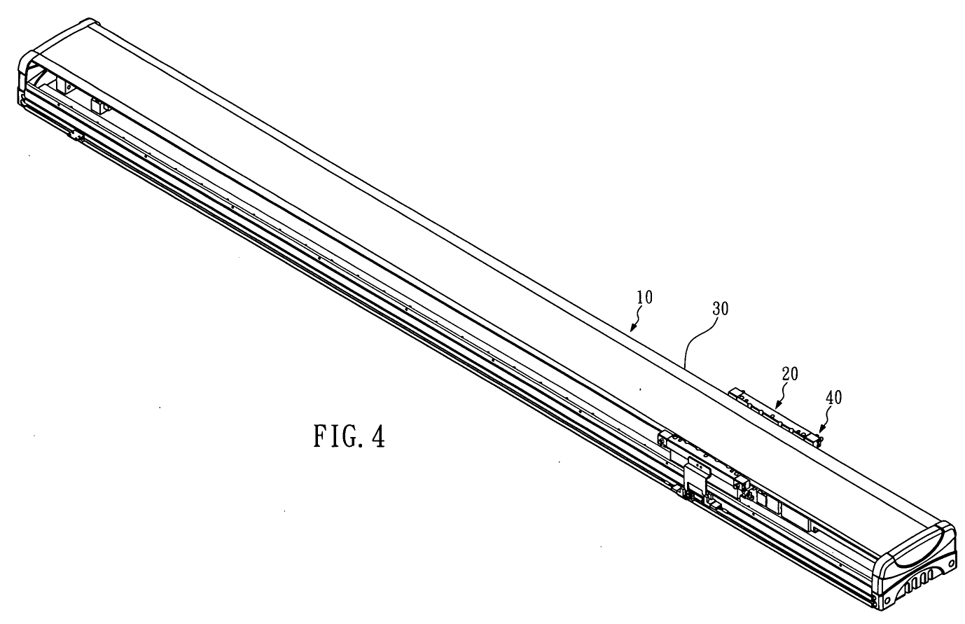

Please refer to FIGS. 1 through 4 for a transmission incorporated with a lubricant filling assembly of the present invention. Therein, the transmission has a housing 10 receiving therein at least one screw 11. At least one nut 111 is mounted around the screw 11 to be pushed to move along the screw 11 by a driving member of the transmission. A slider 20 is further mounted on and driven by the nut 111. The slider 20 bilaterally has at least one exposed portion 21. At least one top cover 30 is placed on the housing 10 in the manner that the top cover 30 and the housing are partially spaced at two sides thereof so as to allow movement of the exposed portions 21 therebetween. At least one said lubricant filling assembly 40 is settled at one said exposed portion 21 of the slider 20. Each said lubricant filling assembly 40 comprises at least one connecting piece 41 having one end attached to an end of the exposed portion 21 of the slider 20. The lubricant filling assembly 40 further has at least one lubricant inlet 42 and at least one air pressure connector 43. At least two countersunk holes 44 are provided on the connecting piece 41 so that at least two screws 45 are allowed to pass through the connecting piece 41 and fasten the connecting piece 41 with the slider 20. The lubricant inlet 42 is fixed to another end of the connecting piece 41 opposite to the end the connecting piece 41 connecting the exposed portion 21. Similarly, the air pressure connector 43 is also fixed to the end of the connecting piece 41 opposite to the end the connecting piece 41 connecting the exposed portion 21.

Thereby, when a lubricant supplying device is implemented to supply lubricant for lubricating the screw 11, by attaching a pipe of the lubricant supplying device to the air pressure connector 43, a lubricant can be directly introduced into the transmission through the lubricant inlet 42 which is exposed at the surface of the transmission, without a need of removing the top cover 30 form the transmission in advance. The lubricant can be then led to the screw 11 by any know technique. As a result, the lubricant can easily reach and lubricate the screw 11 easily despite the location of the transmission in the equipment.

Although the particular embodiment of the invention has been described in detail for purposes of illustration, it will be understood by one of ordinary skill in the art that numerous variations will be possible to the disclosed embodiment without going outside the scope of the invention as disclosed in the claims.

What is claimed is:

1. A lubricant filling assembly for a transmission, said transmission comprising:
a housing receiving therein at least one screw;
at least one nut mounted around the screw and moving along the screw;
a slider mounted on and driven by the nut, said slider having at least one exposed portion at each of two sides thereof; and
at least one top cover such placed on the housing that the top cover and the housing are partially spaced at two sides thereof;
and at least one said lubricant filling assembly settled at one said exposed portion of the slider, the lubricant filling assembly comprising at least one connecting piece which has one end attached to an end of the exposed portion of the slider and includes at least one lubricant inlet and at least one air pressure connector.

2. The lubricant filling assembly of claim 1, wherein two said connecting pieces are connected to two said ends of the exposed portion, respectively.

3. The lubricant filling assembly of claim 1, wherein each said connecting piece has at least two countersunk holes.

4. The lubricant filling assembly of claim 1, wherein each said lubricant inlet is fixed to the connecting piece at another end of the connecting piece opposite to the end the connecting piece connecting the exposed portion.

5. The lubricant filling assembly of claim 1, wherein said air pressure connector is fixed to the connecting piece at another end of the connecting piece opposite to the end the connecting piece connecting the exposed portion.
